(19) United States
(12) Patent Application Publication
(10) Pub. No.: US 2026/0370415 A1
(43) Pub. Date: Nov. 19, 2026

(54) TECHNIQUES FOR ENABLING MULTIPLE EARLY SOUNDING REFERENCE SIGNAL TRANSMISSIONS

(71) Applicant: QUALCOMM Incorporated, San Diego, CA (US)

(72) Inventors: Narayan PRASAD, Westfield, NJ (US); Mostafa KHOSHNEVISAN, San Diego, CA (US); Sony AKKARAKARAN, Poway, CA (US); Qian ZHANG, Basking Ridge, NJ (US); Xiaoxia ZHANG, San Diego, CA (US); Tao LUO, San Diego, CA (US); Junyi LI, Greentown, PA (US)

(21) Appl. No.: 19/630,096

(22) Filed: Mar. 26, 2026

Related U.S. Application Data
(60) Provisional application No. 63/805,083, filed on May 13, 2025.

(51) Int. Cl. H04L 5/00; H04W 74/0833

(52) U.S. Cl. CPC H04L 5/0051; H04W 74/0833

(57) ABSTRACT

Various aspects of the present disclosure generally relate to wireless communication. In some aspects, a user equipment (UE) may receive, via a first message associated with an initial access procedure, an indication that triggers one or more sounding reference signal (SRS) transmissions prior to completion of a radio resource control configuration phase for the UE, wherein the one or more SRS transmissions are associated with at least one of a coherent joint transmission (CJT) multiple transmission reception point (mTRP) initial access procedure or a progressive refinement initial access procedure. The UE may transmit the one or more SRS transmissions based at least in part on the reception of the indication triggering the one or more SRS transmissions. Numerous other aspects are described.

### CROSS-REFERENCE TO RELATED APPLICATION

This Patent Application claims priority to U.S. Provisional Patent Application No. 63/805,083, filed on May 13, 2025, entitled “TECHNIQUES FOR ENABLING MULTIPLE EARLY SOUNDING REFERENCE SIGNAL TRANSMISSIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with enabling multiple early sounding reference signal transmissions.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a user equipment (UE) and a network node may establish a wireless connection using an initial access procedure, such as a random access procedure, among other examples. During an initial access procedure, the UE and the network node may exchange radio resource control (RRC) messages to establish and configure the necessary radio resources and parameters for communication. In some examples, the UE and the network node may negotiate and set up an RRC connection, which may include the allocation of resources, the establishment of security parameters, and the configuration of various protocol layers.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving, via a first message associated with an initial access procedure, an indication that triggers one or more sounding reference signal (SRS) transmissions prior to completion of a radio resource control (RRC) configuration phase for the UE, where the one or more SRS transmissions are associated with at least one of a coherent joint transmission (CJT) multiple transmission reception point (mTRP) initial access procedure or a progressive refinement initial access procedure. The method may include transmitting the one or more SRS transmissions based at least in part on the reception of the indication triggering the one or more SRS transmissions.

Some aspects described herein relate to a method of wireless communication performed by a network node. The method may include transmitting, to a UE via a first message associated with an initial access procedure, an indication that triggers one or more SRS transmissions prior to completion of an RRC configuration phase for the UE, where the one or more SRS transmissions are associated with at least one of a CJT mTRP initial access procedure or a progressive refinement initial access procedure. The method may include receiving, from the UE, at least one SRS transmission, of the one or more SRS transmissions, based at least in part on the transmission of the indication triggering the one or more SRS transmissions.

Some aspects described herein relate to a UE. The UE may include a processing system. The processing system may include one or more processors and one or more code-storing memories coupled with the one or more processors. The processing system may be configured to cause the UE to receive, via a first message associated with an initial access procedure, an indication that triggers one or more SRS transmissions prior to completion of an RRC configuration phase for the UE, where the one or more SRS transmissions are associated with at least one of a CJT mTRP initial access procedure or a progressive refinement initial access procedure. The processing system may be configured to cause the UE to transmit the one or more SRS transmissions based at least in part on the reception of the indication triggering the one or more SRS transmissions.

Some aspects described herein relate to a network node. The network node may include a processing system. The processing system may include one or more processors and one or more code-storing memories coupled with the one or more processors. The processing system may be configured to cause the network node to transmit, to a UE via a first message associated with an initial access procedure, an indication that triggers one or more SRS transmissions prior to completion of an RRC configuration phase for the UE, where the one or more SRS transmissions are associated with at least one of a CJT mTRP initial access procedure or a progressive refinement initial access procedure. The processing system may be configured to cause the network node to receive, from the UE, at least one SRS transmission, of the one or more SRS transmissions, based at least in part on the transmission of the indication triggering the one or more SRS transmissions.

Some aspects described herein relate to a non-transitory computer-readable medium that stores a set of instructions for wireless communication by a UE. The set of instructions, when executed by one or more processors of the UE, may cause the UE to receive, via a first message associated with an initial access procedure, an indication that triggers one or more SRS transmissions prior to completion of an RRC configuration phase for the UE, where the one or more SRS transmissions are associated with at least one of a CJT mTRP initial access procedure or a progressive refinement initial access procedure. The set of instructions, when executed by one or more processors of the UE, may cause the UE to transmit the one or more SRS transmissions based at least in part on the reception of the indication triggering the one or more SRS transmissions.

Some aspects described herein relate to a non-transitory computer-readable medium that stores a set of instructions for wireless communication by a network node. The set of instructions, when executed by one or more processors of the network node, may cause the network node to transmit, to a UE via a first message associated with an initial access procedure, an indication that triggers one or more SRS transmissions prior to completion of an RRC configuration phase for the UE, where the one or more SRS transmissions are associated with at least one of a CJT mTRP initial access procedure or a progressive refinement initial access procedure. The set of instructions, when executed by one or more processors of the network node, may cause the network node to receive, from the UE, at least one SRS transmission, of the one or more SRS transmissions, based at least in part on the transmission of the indication triggering the one or more SRS transmissions.

Some aspects described herein relate to an apparatus for wireless communication. The apparatus may include means for receiving, via a first message associated with an initial access procedure, an indication that triggers one or more SRS transmissions prior to completion of an RRC configuration phase for the apparatus, where the one or more SRS transmissions are associated with at least one of a CJT mTRP initial access procedure or a progressive refinement initial access procedure. The apparatus may include means for transmitting the one or more SRS transmissions based at least in part on the reception of the indication triggering the one or more SRS transmissions.

Some aspects described herein relate to an apparatus for wireless communication. The apparatus may include means for transmitting, to a UE via a first message associated with an initial access procedure, an indication that triggers one or more SRS transmissions prior to completion of an RRC configuration phase for the UE, where the one or more SRS transmissions are associated with at least one of a CJT mTRP initial access procedure or a progressive refinement initial access procedure. The apparatus may include means for receiving, from the UE, at least one SRS transmission, of the one or more SRS transmissions, based at least in part on the transmission of the indication triggering the one or more SRS transmissions.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of physical channels and reference signals in a wireless network.

FIG. 3 is a diagram illustrating an example of a two-step random access procedure.

FIG. 4 is a diagram illustrating an example of a four-step random access procedure.

FIGS. 5A-5C are diagrams of examples associated with enabling multiple early sounding reference signal transmissions.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

Wireless communication systems, such as those supporting 5G and 6G networks, incorporate advanced technologies to improve data rates, reduce latency, and support a broad range of devices and applications. Among these technologies, multiple transmission and reception point (mTRP) configurations (sometimes referred to herein as multi-TRP configurations) are being explored for their ability to enhance signal strength, improve throughput, and provide greater diversity in communication links. Multi-TRP configurations involve utilizing multiple TRPs to serve a single user equipment (UE). These configurations may improve system efficiency and user experience by enabling simultaneous transmissions from multiple TRPs.

In mTRP configurations, transmissions may performed using either coherent or non-coherent modes. Coherent joint transmission (CJT) involves aligning transmissions from multiple TRPs such that they combine constructively at the UE, resulting in higher signal-to-interferences-plus-noise ratios (SINRs) and improved data reception. Achieving CJT may require precise phase and timing information for signals arriving from multiple TRPs. Conversely, non-coherent joint transmission may not rely on phase alignment and instead may employ less stringent feedback mechanisms, which may lead to suboptimal performance due to occasional destructive signal combining. In that regard, although CJT offers superior performance, enabling coherent communication across multiple TRPs may be technically challenging and may require sophisticated coordination and signaling, increasing the complexity of wireless communication systems as compared to those using non-coherent mTRP communications.

Moreover, in traditional mTRP configurations, mTRP transmission schemes are implemented after the UE completes an initial access procedure and enters connected mode (e.g., a radio resource control (RRC) connected mode). This approach enables the network to collect sufficient channel state information, including phase and timing data, to enable CJT. However, delaying mTRP transmission until after an initial access procedure may limit an ability of the network to realize the benefits of CJT during initial access, such as faster ramp-up times for data transmission and improved initial network efficiency. Furthermore, current initial access procedures rely heavily on non-coherent joint transmission methods, which do not leverage the full potential of mTRP configurations due to the absence of phase and timing information required for coherent combining.

Another challenge in mTRP configurations arises from the need for efficient signaling between the UE and the network during initial access. For CJT mTRP communications, the network may need to obtain accurate information about the channels between the UE and multiple TRPs, including relative phase and timing differences. This may require the UE to transmit sounding reference signals (SRSs) early in the initial access procedure to provide the network with the necessary information. However, existing approaches to SRS-triggering during initial access are generally limited to single-TRP configurations or do not incorporate mechanisms for progressive refinement of precoding strategies over successive transmissions. These limitations reduce the ability of the network to optimize beamforming and precoding for downlink transmissions to the UE.

Additionally, the reliance on early SRS transmissions for mTRP configurations introduces challenges related to signaling overhead and resource management. The network may need to configure and trigger SRS transmissions for multiple TRPs, potentially leading to increased complexity in signaling messages exchanged between the UE and the network. Furthermore, contention-based access procedures during initial access may exacerbate the risk of collisions between SRS transmissions from different UEs, particularly when multiple SRS transmissions are required for multi-TRP configurations.

Various aspects relate generally to enabling mTRP CJT and progressive refinement strategies during initial access in wireless communication systems. Some aspects more specifically relate to a network node transmitting, to a UE and via an initial access message, an indication that triggers one or more SRS transmissions prior to completing an RRC configuration phase (with such SRS transmissions sometimes referred to herein as “early SRS transmissions”). These early SRS transmissions enable at least one of CJT mTRP or progressive refinement procedures for initial access. The UE may transmit, to one or more TRPs, the one or more early SRS transmissions based on the received indication, and the network may use these signals to derive phase and timing information for coherent combining or to refine beamforming and precoding strategies.

In some aspects, the UE may receive one or more system information blocks (SIBs) that include configurations supporting early SRS triggering for CJT or progressive refinement. Additionally, or alternatively, the UE may transmit initial access reports, such as synchronization signal block (SSB) measurements or capability information for mTRP strategies, to inform the network about the UE's capabilities and channel conditions. Additionally, the network may configure early SRS transmission parameters, including filters, spreading sequences, offsets, and power control coefficients, via early messages such as message 2, message B, or message 4 in random access channel (RACH) procedures. These configurations may enable the UE to transmit separate SRS signals tailored for individual TRPs or common SRS signals received by multiple TRPs simultaneously.

In some aspects, successive (e.g., non-contiguous) SRS transmissions may be triggered, enabling progressive refinement of precoding strategies based on increasing channel information. For example, the network node may use initial SRS transmissions to derive a basic precoding strategy and trigger subsequent SRS signals to further refine the strategy. Such refinements may enable more accurate beamforming for single TRP or mTRP configurations, improving data throughput and reducing interference.

Particular aspects of the subject matter described in this disclosure can be implemented to realize one or more of the following potential advantages. By enabling triggering of early SRS transmissions for CJT mTRP initial access procedures, the described techniques improve the efficiency of initial access procedures by facilitating higher SINRs and reducing the computational burden associated with non-coherent transmission methods. Early acquisition of phase and timing information through SRS signals may enable the network node to perform coherent combining of signals from multiple TRPs, thereby conserving processing resources required for signal reconstruction and synchronization.

In some aspects, the progressive refinement of precoding strategies based on successive early SRS transmissions enables the network node to adapt to dynamic channel conditions and optimize beamforming accuracy, which may further reduce interference, conserve network resources, and improve spectral efficiency. Additionally, the signaling mechanisms described herein, such as the inclusion of SRS configurations in one or more SIBs and enhanced initial access messages, reduce signaling overhead and streamline resource allocation during initial access procedures. By mitigating SRS collisions and enabling coordinated communication strategies, the proposed techniques enhance computational efficiency and improve resource management in dense deployment scenarios. In this way, the techniques conserve processing resources, network resources, and/or other system resources during complex initial access operations.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

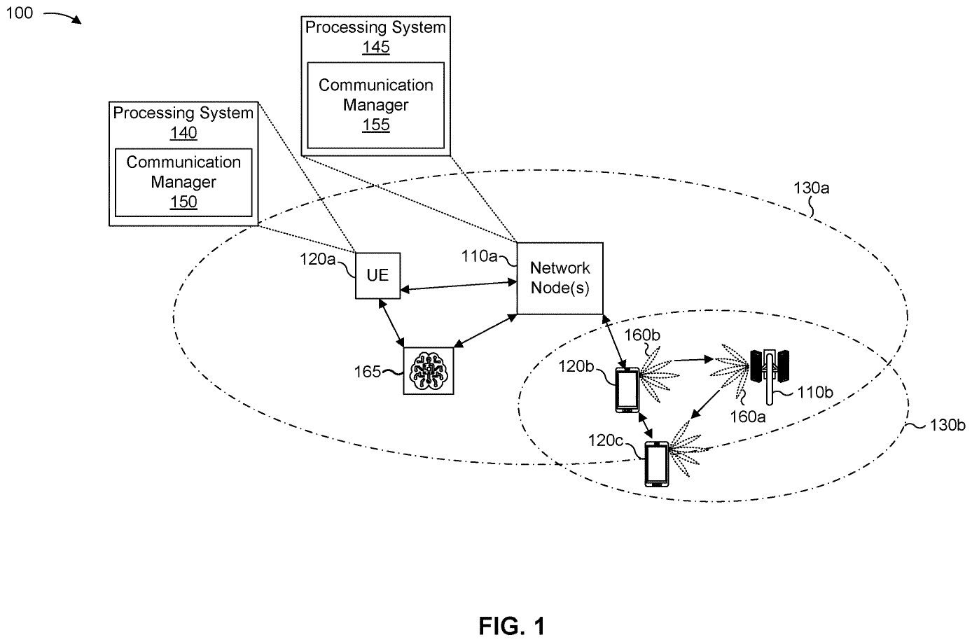

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a

DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, via a first message associated with an initial access procedure, an indication that triggers one or more SRS transmissions prior to completion of an RRC configuration phase for the UE 120, wherein the one or more SRS transmissions are associated with at least one of a CJT mTRP initial access procedure or a progressive refinement initial access procedure; and transmit the one or more SRS transmissions based at least in part on the reception of the indication triggering the one or more SRS transmissions. Additionally, or alternatively, the communication manager 150 may perform one or more other operations described herein.

In some aspects, the network node 110 may include a communication manager 155. As described in more detail elsewhere herein, the communication manager 155 may transmit, to a UE via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure; and receive, from the UE, at least one SRS transmission, of the one or more SRS transmissions, based at least in part on the transmission of the indication triggering the one or more SRS transmissions. Additionally, or alternatively, the communication manager 155 may perform one or more other operations described herein.

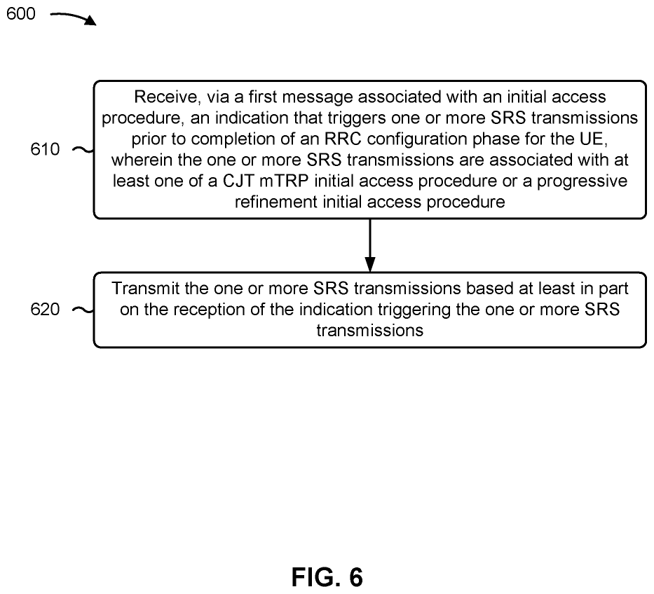

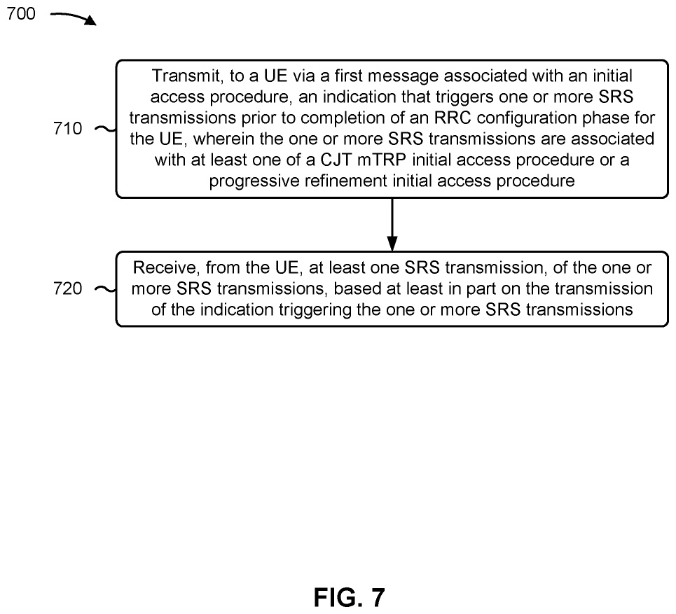

The network node 110, the processing system 145 of the network node 110, the UE 120, the processing system 140 of the UE 120, or any other component(s) of FIG. 1 may implement one or more techniques or perform one or more operations associated with enabling multiple early sounding reference signal transmissions, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

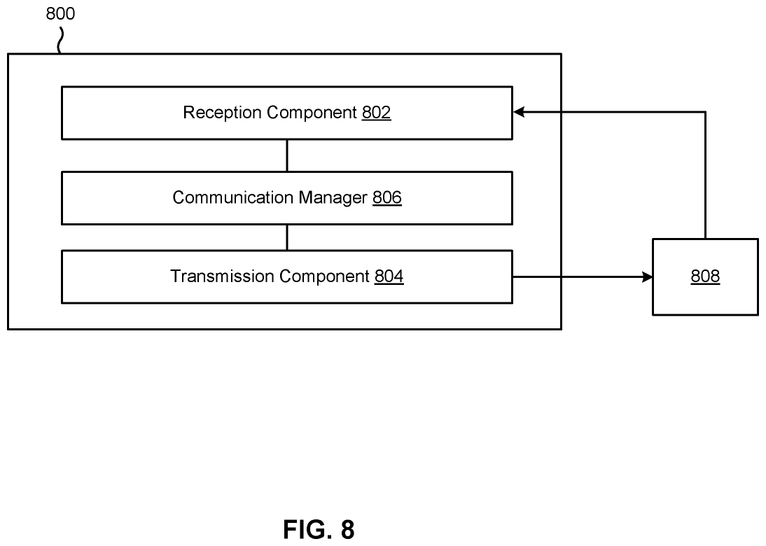

In some aspects, the UE 120 includes means for receiving, via a first message associated with an initial access procedure, an indication that triggers one or more SRS transmissions prior to completion of an RRC configuration phase for the UE 120, wherein the one or more SRS transmissions are associated with at least one of a CJT mTRP initial access procedure or a progressive refinement initial access procedure; or means for transmitting the one or more SRS transmissions based at least in part on the reception of the indication triggering the one or more SRS transmissions. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

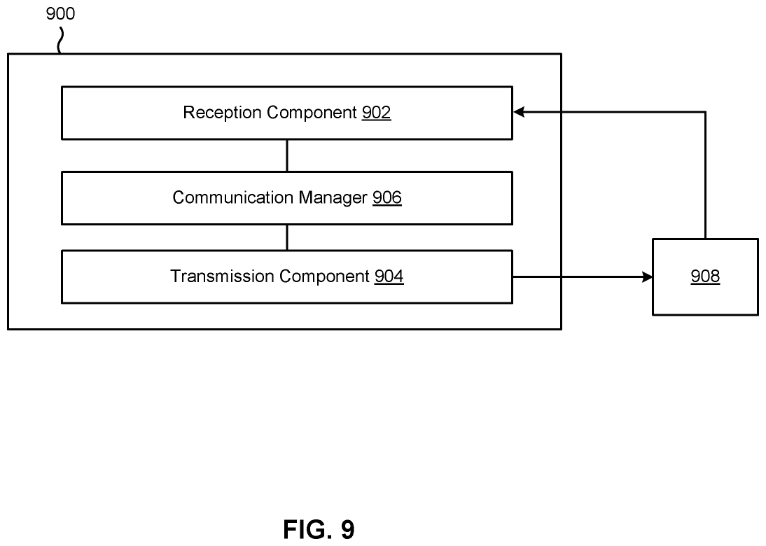

In some aspects, the network node 110 includes means for transmitting, to a UE 120 via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure; or means for receiving, from the UE, at least one SRS transmission, of the one or more SRS transmissions, based at least in part on the transmission of the indication triggering the one or more SRS transmissions. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

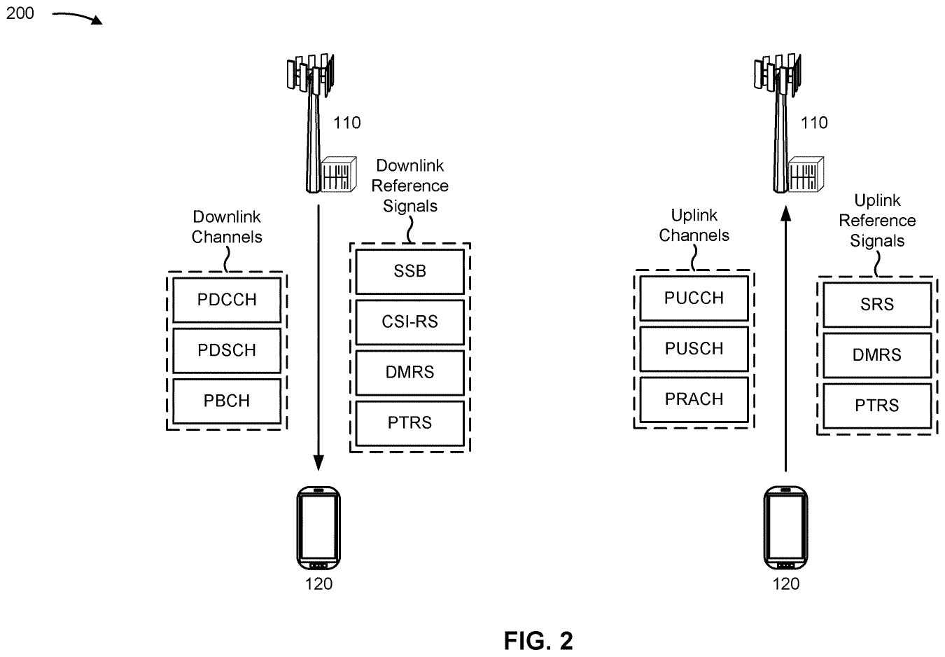

FIG. 2 is a diagram illustrating an example 200 of physical channels and reference signals in a wireless network. As shown in FIG. 2, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a PBCH that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback (e.g., ACK/NACK feedback or ACK/NACK information) in UCI on the PUCCH or the PUSCH.

As further shown, a downlink reference signal may include an SSB, a CSI-RS, a DMRS, a positioning reference signal (PRS), or a PTRS, among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CRI, an LI, an RI, or an RSRP, among other examples. The network node 110 may use the CSI report to select transmission parameters for downlink communications to the UE 120, such as a number of transmission layers (e.g., a rank), a precoding matrix (e.g., a precoder), a MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 2 is provided as an example. Other examples may differ from what is described with regard to FIG. 2.

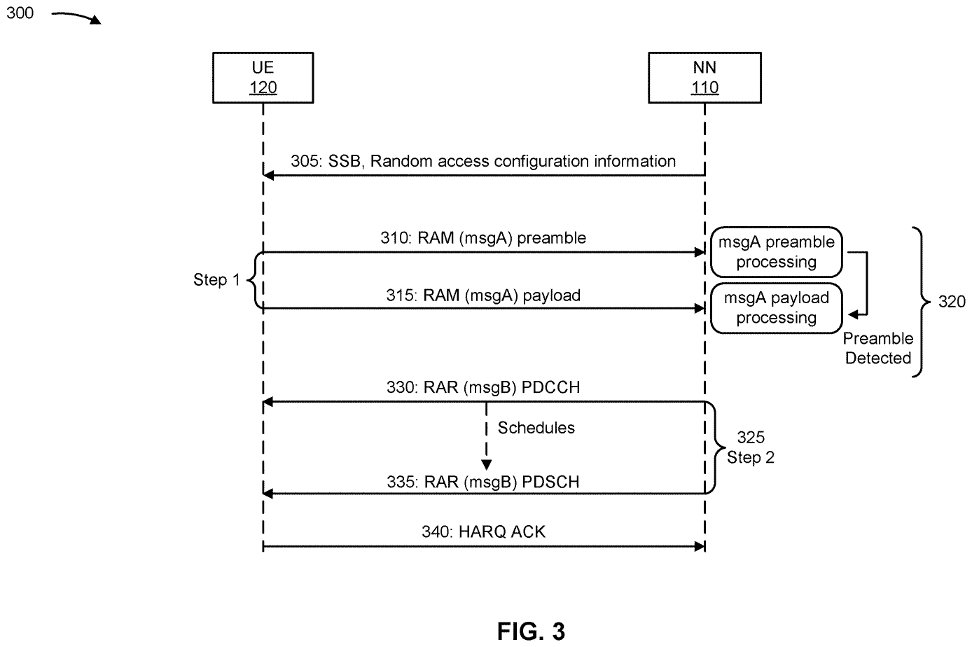

FIG. 3 is a diagram illustrating an example 300 of a two-step random access procedure. As shown in FIG. 3, a network node 110 and a UE 120 may communicate with one another to perform the two-step random access procedure.

As shown by reference number 305, the network node 110 may transmit, and the UE 120 may receive, one or more SSBs and random access configuration information. In some aspects, the random access configuration information may be transmitted in or indicated by system information (e.g., in one or more SIBs) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the two-step random access procedure, such as one or more parameters for transmitting a random access message (RAM)or receiving a random access response (RAR) to the RAM.

As shown by reference number 310, the UE 120 may transmit, and the network node 110 may receive, a RAM preamble. As shown by reference number 315, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, or a PUSCH transmission).

As shown by reference number 320, the network node 110 may receive the RAM preamble transmitted by the UE 120. If the network node 110 successfully receives and decodes the RAM preamble, the network node 110 may then receive and decode the RAM payload.

As shown by reference number 325, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, or contention resolution information.

As shown by reference number 330, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 335, as part of the second step of the two-step random access procedure, the network node 110 may transmit the PDSCH communication for the RAR, as scheduled by the PDCCH communication. The RAR may be included in a MAC protocol data unit (PDU) of the PDSCH communication. As shown by reference number 340, if the UE 120 successfully receives the RAR, the UE 120 may transmit a HARQ ACK.

As indicated above, FIG. 3 is provided as an example. Other examples may differ from what is described with regard to FIG. 3.

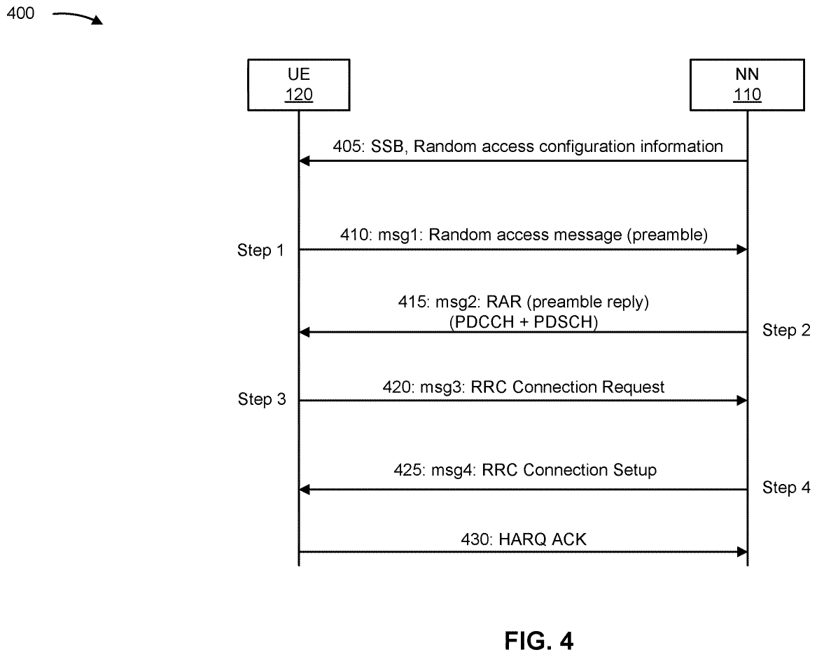

FIG. 4 is a diagram illustrating an example 400 of a four-step random access procedure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some aspects, the random access configuration information may be transmitted in or indicated by system information (e.g., in one or more SIBs) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 430, if the UE 120 successfully receives the RRC connection setup message, the UE 120 may transmit a HARQ ACK.

As indicated above, FIG. 4 is provided as an example. Other examples may differ from what is described with regard to FIG. 4.

In some examples, a data rate associated with communications between the UE 120 and the network node 110 during an initial access period and prior to completion of an RRC configuration phase may be limited. As used herein, “RRC configuration phase” is a stage in an initial access procedure, such as a random access procedure (e.g., one of the random access procedures described above in connection with FIGS. 3 and 4), where the UE 120 and the network node 110 exchange RRC messages to establish and configure the necessary radio resources and parameters for communication. During the RRC configuration phase, the UE 120 and the network node 110 may negotiate and set up an RRC connection, which may include the allocation of resources, the establishment of security parameters, and the configuration of various protocol layers. The RRC configuration phase may enable the UE 120 and the network node 110 to communicate effectively and efficiently, and typically involves the transmission of RRC connection request and setup messages, among other signaling exchanges.

Prior to completion of the RRC configuration phase, the UE 120 and the network node 110 may not be capable of exchanging information enabling mTRP transmissions for initial access procedures, such as for a CJT mTRP initial access procedure, a progressive refinement initial access procedure, or a similar initial access procedure. For example, although non-coherent mTRP initial access procedures may be enabled by a UE 120 reporting observed RSRP measurement results from SSBs transmitted by different TRPs, RSRP measurement results do not contain phase information and thus such RSRP reporting does not enable the network to achieve CJT mTRP transmissions (which may otherwise result in enhanced performance via increased SINR at the UE 120 due to coherent combining of signals transmitted by different TRPs). Instead, to obtain phase information needed for CJT, SRS transmissions by the UE 120 that are received by different TRPs may be required. Additionally, or alternatively, although it may be beneficial to enable progressive refinement via successive (e.g., non-contiguous) early SRS transmissions (e.g., successive SRS transmissions prior to completion of an RRC configuration phase for the UE 120) for improved beamforming or precoding by a network node 110, traditional early signal transmission triggering mechanisms do not support triggering of successive early SRS transmissions. This may result in unnecessarily low data rates during an initial access procedure or RRC configuration phase or immediately after that may otherwise be improved if CJT mTRP communication or progressive refinement via successive (e.g., non-contiguous) SRS transmissions are enabled prior to completion of an RRC configuration phase for the UE 120.

Some techniques and aspects described herein enable early exchange of SRS transmissions, such as for a purpose of enabling CJT mTRP communication or progressive refinement via successive SRS transmissions during an initial access phase. Some aspects more specifically relate to a UE transmitting early SRS transmissions to multiple TRPs to enable a CJT mTRP initial access procedure or else transmitting successive (e.g., non-contiguous) SRS transmissions to one or more TRPs to enable a progressive refinement initial access procedure. In some aspects, a network node may transmit, to a UE via a message associated with an initial access procedure (e.g., msg2, msgB, or msg4, among other examples), an indication that triggers one or more SRS transmissions prior to completion of an RRC configuration phase for the UE (e.g., an indication that triggers one or more early SRS transmissions), such as one or more SRS transmissions associated with a CJT mTRP initial access procedure or one or more SRS transmissions associated a progressive refinement initial access procedure, among other examples. The UE 120 may, in turn, transmit the early SRS transmissions (e.g., SRSs transmitted prior to the completion of the RRC configuration phase) in response to receiving the indication. As a result, the network node and the UE may communicate using CJT mTRP communications or using progressively refined communications during the initial access phase, thus improving a data rate, reducing latency, increasing throughput, and overall resulting in more efficient usage of network resources.

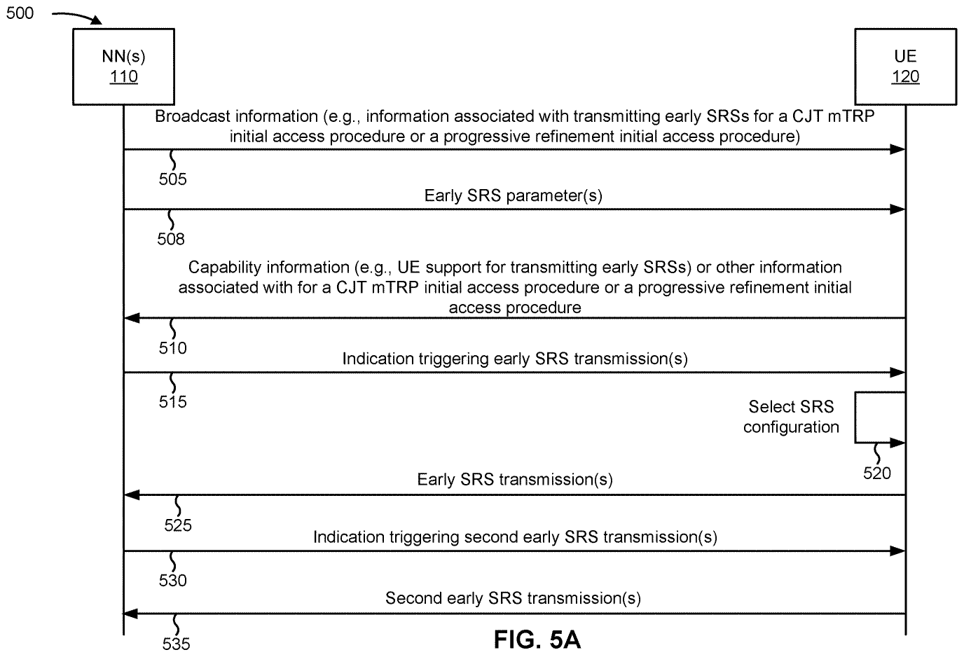

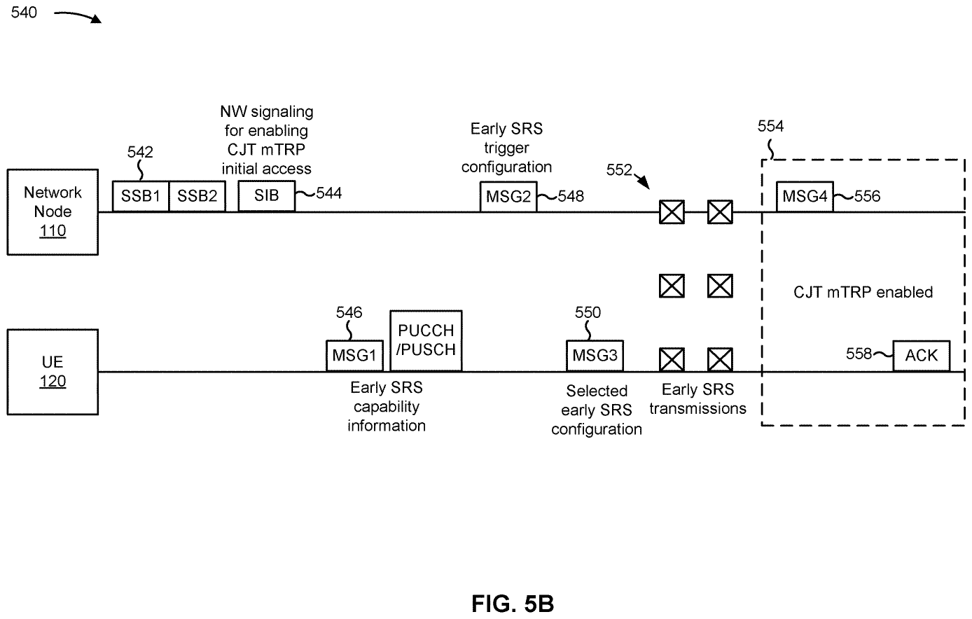

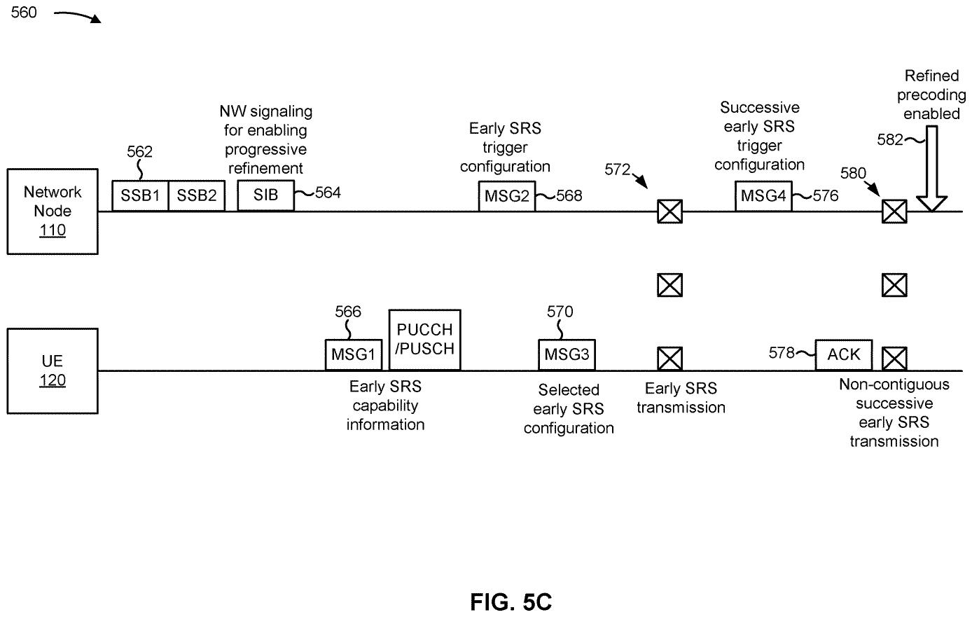

FIGS. 5A-5C are diagrams of examples associated with enabling multiple early SRS transmissions. As shown in FIG. 5A, and by example 500, a network node 110 (e.g., a base station, a CU, a DU, or an RU) may communicate with a UE 120. In some aspects, the network node 110 and the UE 120 may be part of a wireless network (e.g., the wireless communication network 100). In some aspects, the network node 110 and the UE 120 may be in communication (e.g., via the wireless network) as part of an initial access procedure or random access procedure, such as one of the random access procedures described above in connection with FIGS. 3 and 4. Accordingly, in some aspects, some of the messages shown in connection with FIG. 5A may correspond to one or more the RACH messages described above in connection with FIGS. 3 and 4. Additionally, or alternatively, in some aspects, the network node 110 and the UE 120 may exchange communications in addition to those shown in FIG. 5A as part of an initial access procedure, such as one or more of the RACH messages described above in connection with FIGS. 3 and 4.

As shown by reference number 505, the network node 110 may transmit, and the UE 120 may receive, broadcast information. In some aspects, the UE 120 may receive the broadcast information via one or more of system information signaling (e.g., a master information block (MIB), a SIB (e.g., SIB1 or other system information (OSI)), among other examples), or a PBCH, among other examples. As described in more detail below in connection with reference number 515, in some aspects the UE 120 may be indicated to transmit one or more early SRS transmissions (e.g., one or more SRS transmissions that are transmitted prior to completion of an RRC configuration phase for the UE 120), such as one or more early SRS transmissions that are associated with a CJT mTRP initial access procedure or one or more early SRS transmissions that are associated with a progressive refinement initial access procedure. As used herein, “CJT mTRP initial access procedure” refers to a procedure incorporating or enabling one or more CJT communications between multiple TRPs and the UE 120 during initial access (e.g., prior to completion of an RRC configuration phase for the UE 120). For example, a CJT mTRP initial access procedure may enable a network node to perform CJT transmissions before RRC configuration is complete (if the network node chooses to do so) or immediately after RRC configuration is complete without requiring the network node to wait until RRC configuration is complete to start the process of enabling CJT before the network node is ready for using CJT (as in the case in traditional or legacy CJT procedures). “Progressive refinement initial access procedure” refers to a procedure incorporating one or more communications between one or more TRPs and the UE 120 that are performed during the initial access phase and that are associated with at least one of beamforming refinement or precoding refinement based one successive (non-contiguous) SRS transmissions transmitted by the UE 120.

In some aspects, the broadcast information shown in connection with reference number 505 may include information associated with triggering the one or more early SRS transmissions. For example, in some aspects, the network node 110 may transmit, and the UE 120 may receive, a SIB including information enabling the at least one of the CJT mTRP initial access procedure or the progressive refinement initial access procedure. More particularly, the SIB may indicate network supported SRS settings or a class of settings associated with the early SRS transmissions. In some aspects, the SIB may indicate multiple candidate SRS configurations, and the network node 110 may thus later down-select a class of possible SRS configurations from the multiple candidate SRS configurations indicated in the SIB using an initial access message (e.g., msg2 or msgB), which is described in more detail below in connection with reference number 515.

As indicated by reference number 508, in some aspects the network node 110 may transmit, and the UE 120 may receive, one or more early SRS parameters via an initial access message, such as msg2 or msgB, among other examples. For example, in some aspects the network node 110 may indicate or trigger (e.g., via msg2 or a similar initial access message) multiple non-zero-power CSI-RSs (NZP-CSI-RSs) to be transmitted by multiple TRPs via the signaling shown in connection with reference number 508.

Additionally, or alternatively, in aspects involving two or more TRPs (e.g., in aspects involving mTRP communications), the one or more early SRS parameters may include an indication of multiple path loss reference signals (PL-RSs) based on multiple selected SSBs (e.g., one from each TRP) that were reported by UE 120 in an initial access message, such as msg1. Additionally, or alternatively, the one or more early SRS parameters may indicate one or more timing advance (TA) values to be used by the UE 120 to transmit multiple early SRS transmissions. In some aspects, certain early SRS parameters may be common to all early SRS transmissions, and certain other early SRS parameters may be per SRS and thus may be separately indicated or implicitly derived based on indication of just one of the parameters. For example, if the UE 120 is without multibeam transmission capability, the UE 120 may require that multiple SRSs be time division multiplexed (TDMed). In such aspects, each SRS may be associated with a corresponding slot/symbol offset, and the UE 120 may be capable of deriving an offset of a second-in-time SRS from a time-domain location of a first-in-time SRS by using a fixed additional offset (which may be fixed in a relevant wireless communication standard, such as 3GPP, or signaled in an earlier message, such as SIB, among other examples).

In some aspects, the one or more early SRS parameters may be associated with a common SRS transmission that is received by multiple TRPs to derive the joint precoding for CJT (which is described in more detail below in connection with reference number 525), such as in aspects involving FR1 or emulating distributed antennas, among other examples. In such aspects, power control for the SRS transmission may be a function of multiple SSBs selected and reported via the signaling shown in connection with reference number 508 (e.g., msg1), such as for a purpose of deriving a single power value for the common SRS transmission. More particularly, in some aspects, the SRS transmit power, P, may be derived using the expression P=P₀+10 log₁₀M+ƒᵢₙᵢₜ (α₁~PL₁, α₂~PL₂, . . ., α_{N}~PL_{N})+h, where (αᵢ, PLᵢ)∀i, denote alpha and path loss values for the i^{th} TRP, respectively. In such aspects, via the signaling shown in connection with reference number 508 (e.g., msg2 or msgB), the network node 110 may transmit an indication of αᵢ and an index of an associated TRP SSB or other underlying parameters for the UE 120 to derive SRS transmit power. In that regard, the function, ƒᵢₙᵢₜ (.,.,...), and the alpha values {αᵢ}, ∀i, may be specialized to initial access and may be different from their counterparts (if any) used for connected mode mTRP reception. In some aspects, a maximum number of alpha values, N, that the UE 120 may support for uplink power control of one SRS resource set in initial access may be indicated by the UE 120 (e.g., using msg1 or msgA).

In some aspects, parameter h may be omitted from the SRS transmit power expression (e.g., h may not be relevant enough in the RACH stage and may be dropped). In some other aspects, the value of h may be signaled by the network node 110 to the UE 120 (e.g., msg2, msg4, msgB, or a similar message). Additionally, or alternatively, to mitigate overloading the PRACH with all the above capabilities, the network may have a default rule (e.g., a rule defined by a relevant wireless communication standard, such as 3GPP) in which the same alpha is reused if the UE 120 is only capable of understanding N out of K values signaled by the network node 110 (where N<K). Moreover, in aspects in which the UE 120 measured N1 path loss metrics but can only select N2 TRPs (where N2<N1), the network may have a default rule (e.g., a rule defined by a relevant wireless communication standard, such as 3GPP) in which the UE 120 is to select TRPs with the best (e.g., top N2) path loss values.

As indicated by reference number 510, the UE 120 may transmit via an initial access message (e.g., msg1 or msgA, among other examples), and the network node 110 may receive, capability information or other information associated with the CJT mTRP initial access procedure or the progressive refinement initial access procedure. For example, in some aspects, the capability information may indicate whether the UE 120 supports CJT mTRP initial access procedures or progressive refinement initial access procedures. Additionally, or alternatively, the initial access message shown in connection with reference number 510 may include a report indicating L1 measurement results associated with SSBs transmitted by multiple network nodes, or downlink timing differences associated with the SSBs transmitted by the multiple network nodes, among other examples.

More particularly, in some aspects, the UE 120 may transmit a msg1 or msgA that has an associated PUSCH/PUCCH report containing an SSB L1-RSRP/L1-SINR report for each TRP associated with the CJT mTRP initial access procedure. In some other aspects, the UE 120 may transmit a msg1 or msgA that has an associated PUSCH/PUCCH report containing downlink timing differences across SSBs received from different TRPs (e.g., relative to a pre-configured TRP, which may be indicated by the SIB described above in connection with reference number 505). In such aspects, the UE 120 may first estimate the timing differences across SSBs, and, based at least in part on a pre-configured threshold provided by the network node 110 (e.g., via SIB) and the detected timing differences, the UE 120 may determine the TRPs that are to be included in the report. In that regard, the network node 110 may provide a threshold specific for enabling CJT mTRP in initial access (e.g., via the SIB described above in connection with reference number 505). Additionally, or alternatively, frequency or phase offsets among TRPs may be reported by the UE 120 (e.g., the UE 120 may report frequency or phase offsets obtained by UE 120 relying on SSBs). In some other aspects, the UE 120 may transmit a msg1 or msgA that has an associated PUSCH/PUCCH report containing the UE 120's SRS capability information, such as one or more of codebook (CB) SRS support, non-codebook (NCB) SRS support, or antenna switching SRS support, among other examples.

In some aspects, the UE 120 may indicate capability information using msg1 or msgA parameters themselves (e.g., instead of, in addition to, the PUSCH/PUCCH report described above). For example, in some aspects, msg1 PRACH parameters may themselves be updated to indicate some of the above features along with UE 120's capability information (e.g., the PRACH parameters may be used to sub-select one or more parameters from ones indicated in the SIB described above in connection with reference number 505). Moreover, in some aspects the signaling shown in connection with reference number 510 (e.g., msg1 or msgA, among other examples) may indicate capability information indicating a maximum quantity (e.g., N) of power control coefficients supported by the UE 120, such as in aspects in which the UE 120 is to determine the SRS transmit power using the expression P₀+10 log₁₀M+ƒᵢₙᵢₜ (α₁~PL₁, α₂~PL₂, . . . , α_{N}~PL_{N})+h, as described above in connection with reference number 508.

Additionally, or alternatively, in some aspects, the UE 120 may transmit a report indicating frequency or phase offsets among TRPs that are based at least in part on CSI-RSs transmitted by the multiple TRPs. For example, the network node 110 may indicate or trigger (e.g., via msg2 or a similar initial access message) NZP-CSI-RSs to be transmitted by multiple TRPs. In such aspects, the UE 120 may receive, from multiple network nodes, multiple CSI-RSs (e.g., multiple NZP-CSI-RSs); the UE 120 may determine, using the multiple CSI-RSs, at least one of phase offsets or frequency offsets associated with the multiple network nodes; and the UE 120 may transmit, using an initial access message (e.g., msg3), an indication of the at least one of the phase offsets or the frequency offsets associated with the multiple network nodes. Accordingly, in some aspects, at least a portion of the signaling shown in connection with reference number 510 may be transmitted using msg3, which is described in more detail below.

In some aspects, the signaling shown in connection with reference number 510 may indicate a set of network nodes (e.g., TRPs) to be used for a CJT mTRP initial access procedure. For example, the UE 120 may signal, via msg1 or msgA, a set of TRPs for the CJT, and the network node 110 may indicate (e.g., via msg2 or msgB) a subset of those indicated TRPs for actual SRS sounding and CJT operation (which is described in more detail below in connection with reference number 515). For example, the UE 120 may indicate four candidate TRPs to be used for the initial access procedure (e.g., a CJT mTRP initial access procedure) via msg1 or msgA, and the network node 110 may, in turn, indicate a subset of the four candidate TRPs (e.g., two TRPs) for SRS sounding and CJT operation. In this regard, in aspects in which the one or more early SRS transmissions are associated with the CJT mTRP initial access procedure, the set of network nodes (e.g., TRPs) to be used for a CJT mTRP initial access procedure (sometimes referred to herein as a CJT set or a CJT group) may be indicated by the network node 110 (e.g., via msg2 or msgB, among other examples) based at least in part on measurement results transmitted by the UE 120 to the network node 110, or selected by the UE 120 and reported to the network node 110 via a message associated with the initial access procedure (e.g., msg1 or msgA, among other examples).

As indicated by reference number 515, the network node 110 may transmit, and the UE 120 may receive, via a message associated with an initial access procedure (e.g., msg2 or msgB, among other examples), an indication that triggers one or more SRS transmissions prior to completion of an RRC configuration phase for the UE 120 (e.g., an indication that triggers one or more early SRS transmissions). As described above, in some aspects, the one or more early SRS transmissions may be associated with a CJT mTRP initial access procedure, and, in some other aspects, the one or more early SRS transmissions may be associated with a progressive refinement initial access procedure.

Additionally, or alternatively, the message including the indication that triggers the one or more early SRS transmissions may be one of the initial access messages described above in connection with FIGS. 3 and 4, such as msg2 associated with a four-step RACH procedure, msg4 associated with the four-step RACH procedure, or msgB associated with a two-step RACH procedure, among other examples. For example, in aspects in which the UE 120 reports its capability or other SRS information (e.g., the information described above in connection with reference number 510) via msg1 or msgA, the message including the indication that triggers the one or more early SRS transmissions may be msg2 or msgB, respectively. On the other hand, in aspects in which the UE 120 reports its capability or other SRS information (e.g., the information described above in connection with reference number 510) via msg3, the message including the indication that triggers the one or more early SRS transmissions may be msg4, among other examples.

More particularly, in some aspects, the UE 120 may report capability information using msg3 (e.g., the message shown in connection with reference number 510 may be msg3) and thus the network node 110 may trigger the one or more early SRS transmissions using msg4 (e.g., the message shown in connection with reference number 515 may be msg4). In such aspects, the one or more early SRS transmissions (described in more detail below in connection with reference number 525) may be sounded by the UE 120 with or after a msg4 ACK message. In this regard, over-burdening of msg1 may be avoided or the benefit of CJT mTRP initial access communications may be achieved for transmissions beyond msg4 (e.g., subsequent PDSCH). In a two-step random access procedure, the network node 110 may indicate in one or more SIBs that the network node 110 is ready to receive msgA in addition to one or more early SRS transmissions (e.g., the SIB may be used to trigger the one or more early SRS transmissions and thus the message shown in connection with reference number 515 may be a SIB), and thus CJT mTRP transmissions may be used for msgB or after the network node 110 receives ACK for msgB.

In some aspects, the message including the indication that triggers the one or more early SRS transmissions may indicate configuration information associated with transmitting the one or more early SRS transmissions, such as an SRS transmission filter (or QCL source reference signal (RS) to determine transmission filter) associated with the one or more SRS transmissions, an SRS spreading sequence (or root sequence index and cyclic shift) associated with the one or more SRS transmissions, a comb associated with the one or more SRS transmissions, an offset (e.g., time offset from signal triggering the SRS) associated with the one or more SRS transmissions, or a power control parameter associated with the one or more SRS transmissions. Other configuration information may include a quantity of ports, a total quantity of symbols per one or more SRS transmissions, a symbol repetition factor, symbol locations in the corresponding slot, RB range, frequency hopping pattern across different repetitions, or time/frequency location per repetition, among other examples. Put another way, the signaling shown in connection with reference number 515 may indicate configuration information that indicates (e.g., for each TRP in a CJT set or group, among other examples) a UE SRS transmission filter, a spreading sequence, combs, offsets, a number of OFDM symbols parameter, a start of an OFDM symbol parameter, or power control parameters, among other examples. In aspects in which the signaling indicates the number of OFDM symbols parameter or the start of the OFDM symbol parameter, a tone offset may be indicated per OFDM symbol, with a stagger pattern across OFDM symbols (e.g., used in SRS-for-positioning) or common across OFDM symbols. Additionally, or alternatively, and as described above in connection with reference number 510, in some aspects the signaling shown in connection with reference number 515 may indicate multiple PL-RSs associated with the CJT mTRP initial access procedure, multiple TA parameters associated with the one or more SRS transmissions, or multiple offset values associated with the one or more SRS transmissions, among other examples.

In some aspects, the signaling shown in connection with reference number 515 may further indicate a selected class of SRS configurations to be used for the one or more SRS transmissions. For example, the network node 110 may indicate (e.g., via msg2 or msgB) a selected class of SRS configurations to be used for the one or more SRS transmissions (e.g., msg2 or msgB may be used to down-select a class of possible SRS configurations from those indicated in the one or more SIBs described above in connection with reference number 505). In such aspects, and as indicated by reference number 520, the UE 120 may select an SRS configuration, of multiple candidate SRS configurations indicated by the SIB, that is associated with the selected class of SRS configurations indicated by the network node 110. Additionally, or alternatively, the UE 120 may transmit, and the network node 110 may receive, an indication of the selected SRS configuration, such as via msg3, among other examples. Put another way, the UE 120 may use msg3 to report the SRS configurations that are selected by the UE 120 to be used for the SRS soundings.

In some aspects, the signaling shown in connection with reference number 515 may indicate a selection of a CJT set or group for a CJT mTRP initial access procedure (e.g., the signaling shown in connection with reference number 515 may be used to indicate which TRPs are to receive SRS transmissions from the UE 120). In such aspects, the CJT set or group for the CJT mTRP initial access procedure may be selected by the network node 110 based on a msg1 report (e.g., one or more of the reports described above in connection with reference number 510). More particularly, the TRP group or set for the CJT mTRP initial access procedure may be selected by the network node 110 based on L1-RSRPs or L1-SINRs indicated via msg1, among other examples. Additionally, or alternatively, in some aspects the UE 120 may be configured to report suitable TRP groups for CJT (e.g., via the msg1 report).

In some aspects, the message shown in connection with reference number 515 may be a msg2 that is transmitted by the network node 110 to the UE 120 using non-coherent JT based on a group of TRPs. In such aspects, the msg2 may indicate an SRS configuration for the group of TRPs. In aspects involving separate SRS transmissions to be transmitted to each TRP in the group (which is described in more detail below in connection with reference number 525), the UE 120 may sound SRS accordingly or else sound SRS for only a subset of the TRPs (with the subset choice being indicated via msg3, in a similar manner as described above in connection with reference number 520).

As indicated by reference number 525, the UE 120 may transmit, and the network node 110 may receive, one or more early SRS transmissions based at least in part on the UE 120 receiving the indication triggering the one or more SRS transmissions (e.g., the indication described above in connection with reference number 515). Moreover, in some aspects the one or more SRS transmissions may be associated with the CJT mTRP initial access procedure, and, in some other aspects, the one or more SRS transmissions may be associated with the progressive refinement procedure.

In aspects in which the one or more SRS transmissions are associated with the CJT mTRP initial access procedure, the one or more SRS transmissions may include either a first SRS transmission that is transmitted to a first network node (e.g., a first TRP) and a second SRS transmission that is transmitted to a second network node (e.g., a second TRP), or else a common SRS transmission that is transmitted to multiple network nodes (e.g., multiple TRPs). Put another way, the CJT mTRP initial access procedure may be associated with separate SRS transmissions for each of the different TRPs in the CJT set (sometimes referred to herein as TRP-dedicated SRS transmissions) or else a common SRS transmission that can be received by multiple TRPs in the CJT set. In some aspects, a combination of TRP-dedicated SRS transmissions and common SRS transmissions may be used. For example, multiple soundings of each SRS may be allowed, and the network node 110 may configure (e.g., via the signaling described above in connection with reference number 505) separate SRS resource sets configurations (sometimes referred to as SRS-ResourceSet configurations) with separate SRS identifiers (SRSIs) for TRPs for a given usage (e.g., one of codebook, non-codebook, antenna switching, or beam management). Additionally, or alternatively, the network node 110 may configure an SRS resource set for multiple usages, if supported by the UE 120.

Moreover, as described above in connection with reference number 515, in aspects in which the one or more SRS transmissions include a common SRS transmission that is transmitted to multiple network nodes, the indication that triggers the one or more SRS transmissions may indicate multiple power control coefficients associated with a power control function for transmitting the common SRS transmission to the multiple network nodes. In such aspects, the UE 120 may transmit the one or more early SRS transmissions based at least in part on using an SRS transmit power derived from the power control function.

Additionally, or alternatively, in some aspects the UE 120 may transmit a first SRS transmission, of the one or more SRS transmissions, using a first cyclic shift, and transmit a second SRS transmission, of the one or more SRS transmissions, using a second cyclic shift that is different from the first cyclic shift. In some other aspects, the UE 120 may transmit the first SRS transmission using a first root sequence, and may transmit the second SRS transmission using a second root sequence that is different from the first root sequence. Put another way, the UE 120 may transmit the one or more early SRS transmissions by introducing randomization via changing the cyclic shifts or root sequences used in the UE 120's SRS soundings, and the UE 120 may indicate the changed parameters to the network node 110, such as via msg3. In such aspects, changing the cyclic shifts or root sequences may mitigate an impact of collisions in aspects involving contention-based initial access (which can be exacerbated due to multiple SRS soundings by the UE 120). Additionally, or alternatively, changing the cyclic shifts or root sequences may be implicitly indicated based on a slot or system frame number (SFN) used by the UE 120 (in which case the UE 120 may omit indicating the changed parameters to the network node 110 via msg3 or otherwise).

In some other aspects, the UE 120 may transmit the first SRS transmission using a first offset value, and may transmit the second SRS transmission using a second offset value that is different from the first offset value. For example, the network node 110 may configure (e.g., via the one or more SIBs described above in connection with reference number 505) different start positions of OFDM symbols associated with the one or more early SRS transmissions across transmission occasions, among other examples.

In some aspects, a CJT mTRP initial access procedure may include at least three main steps. In a first step, the UE 120 may select a set of candidate TRPs for CJT operation, such as based on SSB measurements or CSI-RS (e.g., NZP-CSI-RS) measurements performed by the UE 120. In a second step, the network node 110 may select a subset of the UE-selected TRP set for SRS triggering, which may include separate SRSs for each TRP or a common SRS to be transmitted to all TRPs in which power control is a function of the whole subset. In a third step, the UE 120 may transmit the one or more early SRS transmissions, and the network node 110, based on SRS reception, may indicate a further down-selection for PDSCH CJT. As described above, these three steps may be accomplished using various combinations of initial access messages. For example, in a first aspect, the first step may be performed using msg1 PRACH or msgA PRACH, the second step may be performed using msg2 PDCCH or PDSCH, and the third step may be performed using msg4 PDCCH. In a second aspect, the first step may be performed using msg3 PUSCH, the second step may be performed using msg4 PDCCH or PDSCH, and the third step may be performed using subsequent DCI (e.g., fallback DCI) after msg4 but before transmission of a dedicated RRC configuration. Additional aspects may be derived upon merging the second step and the third step into a single message or else removing one of the second step or the third step. Additional aspects involving the CJT mTRP initial access procedure are described in more detail below in connection with FIG. 5B.

As described above, in some other aspects, the one or more early SRS transmissions may be associated with a progressive refinement initial access procedure in which successive (e.g., non-contiguous) SRS transmissions are transmitted by the UE 120 and used by the network node 110 to refine beamforming or precoding during the initial access procedure, among other examples. In such aspects, the UE 120 may transmit a first early SRS transmission in the signaling shown in connection with reference number 525, and then may later transmit a second early SRS transmission (e.g., a non-contiguous early SRS transmission) to be used for the progressive refinement initial access procedure.

In such aspects, and as indicated by reference number 530, the network node 110 may transmit, and the UE 120 may receive, an indication that triggers a second SRS transmission. For example, the network node 110 may trigger a first early SRS transmission associated with the progressive refinement initial access procedure using the signaling described above in connection with reference number 515 (e.g., msg2), and, optionally, the UE 120 may indicate a specific SRS configuration used for the first early SRS transmission via msg3 (in a similar manner as described above in connection with reference number 520). Moreover the network node 110 may then trigger a second early SRS transmission, such as via msg4 (e.g., the signaling shown in connection with reference number 530 may be msg4). In such aspects, msg4 may indicate and trigger one or more additional early SRS transmissions by the UE 120, as indicated by reference number 535.

In some aspects, the UE 120 may transmit the first early SRS transmission (e.g., the early SRS transmission shown in connection with reference number 525) to a first network node or TRP, and the UE 120 may the second early SRS transmission (e.g., the early SRS transmission shown in connection with reference number 535) to a second network node or TRP. Put another way, the one or more SRS transmissions triggered by the signaling shown in connection with reference number 530 (e.g., msg4) may be towards (or indicated for) different TRPs than the one or more the one or more SRS transmissions triggered by the signaling shown in connection with reference number 515 (e.g., msg2). In some other aspects, the UE 120 may transmit the first early SRS transmission (e.g., the early SRS transmission shown in connection with reference number 525) to a network node or TRP using a first subset of UE transmission ports, and the UE 120 may the second early SRS transmission (e.g., the early SRS transmission shown in connection with reference number 535) to the network node or TRP using a second subset of UE transmission ports. Put another way, the one or more SRS transmissions triggered by the signaling shown in connection with reference number 530 (e.g., msg4) may be towards (or indicated for) the same TRP as the one or more the one or more SRS transmissions triggered by the signaling shown in connection with reference number 515 (e.g., msg2) but may be sounded using different subsets of UE ports.

In some other aspects, the UE 120 may transmit the one or more second early SRS transmissions (e.g., the SRS transmissions shown in connection with reference number 535) with or after a msg4 ACK message. In some aspects, the successive (e.g., non-contiguous) SRS soundings (e.g., the one or more early SRS transmissions described above in connection with reference number 525 and the one or more early SRS transmissions described above in connection with reference number 535) may enable the network node 110 to perform refined precoding for subsequent transmissions to the UE 120 (e.g., subsequent PDSCH transmissions during the initial access procedure). Additional aspects involving the progressive refinement initial access procedure are described in more detail below in connection with FIG. 5C.

FIG. 5B shows an example 540 of a CJT mTRP initial access procedure that may be enabled using the techniques and signaling described herein. Although for ease of description the example 540 is described in connection with a four-step RACH procedure, in some other aspects a similar procedure may be performed in connection with a different type of initial access procedure, such as a two-step RACH procedure, among other examples.

As indicated by reference number 542, the network node 110 may transmit one or more SSBs (shown as a first SSB (SSB1) and a second SSB (SSB2) in FIG. 5B) that may be received or measured by the UE 120. Additionally, or alternatively, as indicated by reference number 544, the network node 110 may transmit one or more SIBs that may be received by the UE 120. In some aspects, the one or more SIBs may include network signaling for enabling CJT mTRP initial access, such as any of the information or parameters described above in connection with reference numbers 505 or 508.

As indicated by reference number 546, the UE 120 may transmit msg1, which may include an associated PUCCH or PUSCH. In some aspects, the msg1 or the associated PUCCH or PUSCH may include early SRS capability information, among other information, such as any of the information described above in connection with reference number 510. As indicated by reference number 548, the network node 110 may transmit msg2, which may include an early SRS trigger configuration (e.g., which may include an indication triggering one or more early SRS transmissions). In that regard, msg2 may include any of the information described above in connection with reference number 515.

As indicated by reference number 550, the UE 120 may transmit msg3, which may indicate a selected early SRS configuration, in a similar manner as described above in connection with reference number 520. Moreover, as indicated by reference number 552, the UE 120 may transmit one or more early SRS transmissions. As described above in connection with reference number 525, in some aspects the UE 120 may transmit a common early SRS transmission that is received by multiple TRPs (e.g., each TRP in a CJT set), and, in some other aspects, the UE 120 may transmit a respective early SRS transmission to each TRP (e.g., each TRP in the CJT set).

In that regard, the one or more early SRS transmissions indicated by reference number 552 may enable CJT mTRP communications during the initial access phase. Accordingly, as indicated by reference number 554, CJT mTRP communication may be enabled for the remainder of the initial access phase. More particularly, as indicated by reference number 556, the network node 110 may transmit msg4 using CJT mTRP communication. Additionally, or alternatively, as indicated by reference number 558, the UE 120 may transmit a msg4 ACK based at least in part on receiving msg4.

FIG. 5C shows an example 560 of a progressive refinement initial access procedure that may be enabled using the techniques and signaling described herein. Although for ease of description the example 560 is described in connection with a four-step RACH procedure, in some other aspects a similar procedure may be performed in connection with a different type of initial access procedure, such as a two-step RACH procedure, among other examples.

As indicated by reference number 562, the network node 110 may transmit one or more SSBs (e.g., SSB1 and SSB2) that may be received or measured by the UE 120. Additionally, or alternatively, as indicated by reference number 564, the network node 110 may transmit one or more SIBs that may be received by the UE 120. In some aspects, the one or more SIBs may include network signaling for enabling progressive refinement during initial access, such any of the information or parameters described above in connection with reference numbers 505 or 508.

As indicated by reference number 566, the UE 120 may transmit msg1, which may include an associated PUCCH or PUSCH. In some aspects, the msg1 or the associated PUCCH or PUSCH may include early SRS capability information, among other information, such as any of the information described above in connection with reference number 510. As indicated by reference number 568, the network node 110 may transmit msg2, which may include an early SRS trigger configuration (e.g., an indication triggering one or more early SRS transmissions). In that regard, msg2 may include any of the information described above in connection with reference number 515.

As indicated by reference number 570, the UE 120 may transmit msg3, which may indicate a selected early SRS configuration, in a similar manner as described above in connection with reference number 520. Moreover, as indicated by reference number 572, the UE 120 may transmit one or more early SRS transmissions. As described above in connection with reference number 525, in some aspects the one or more early SRS transmissions indicated by reference number 572 may include a first SRS transmission of successive (non-contiguous) SRS transmissions to be used for the progressive refinement initial access procedure.

As indicated by reference number 576, the network node 110 may transmit msg4, which may include a successive early SRS trigger configuration. In that regard, msg4 may include any of the information described above in connection with reference number 530. As indicated by reference number 578, the UE 120 may transmit a msg4 ACK message acknowledging reception of the successive early SRS trigger configuration. Accordingly, as indicated by reference number 580, the UE 120 may transmit one or more early SRS transmissions. As described above in connection with reference number 535, in some aspects the one or more early SRS transmissions indicated by reference number 580 may include a second SRS transmission of successive (non-contiguous) SRS transmissions to be used for the progressive refinement initial access procedure. Accordingly, as indicated by reference number 582, the network node 110 may perform a progressive refinement operation using the successive (non-contiguous) early SRS transmissions. For example, refined precoding may be enabled at the network node 110 for the remainder initial access procedure, among other examples.

Based at least in part on the UE 120 and the network node 110 performing the CJT mTRP initial access procedure or the progressive refinement initial access procedure described above, the UE 120 or the network node 110 may conserve computing, power, network, or communication resources that may have otherwise been consumed traditional initial access procedures. For example, based at least in part on the UE 120 and the network node 110 performing the CJT mTRP initial access procedure or the progressive refinement initial access procedure described above, the UE 120 and the network node 110 may communicate with faster data rates, improved network efficiency, and a reduced error rate, which may conserve computing, power, network, or communication resources that may have otherwise been consumed by traditional initial access procedures or to detect or correct communication errors.

FIG. 6 is a diagram illustrating an example process 600 performed, for example, at a UE or an apparatus of a UE. Example process 600 is an example where the apparatus or the UE (e.g., UE 120) performs operations associated with enabling multiple early SRS transmissions.

As shown in FIG. 6, in some aspects, process 600 may include receiving, via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure (block 610). For example, the UE (e.g., using reception component 802 or communication manager 806, depicted in FIG. 8) may receive, via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure, as described above.

As further shown in FIG. 6, in some aspects, process 600 may include transmitting the one or more SRS transmissions based at least in part on the reception of the indication triggering the one or more SRS transmissions (block 620). For example, the UE (e.g., using transmission component 804 or communication manager 806, depicted in FIG. 8) may transmit the one or more SRS transmissions based at least in part on the reception of the indication triggering the one or more SRS transmissions, as described above.

Process 600 may include additional aspects, such as any single aspect or any combination of aspects described below or in connection with one or more other processes described elsewhere herein.

In a first aspect, process 600 includes receiving, via a system information block, information enabling the at least one of the CJT mTRP initial access procedure or the progressive refinement initial access procedure.

In a second aspect, alone or in combination with the first aspect, process 600 includes transmitting, via a second message associated with the initial access procedure, a report indicating at least one of layer 1 measurement results associated with SSBs transmitted by multiple network nodes, downlink timing differences associated with the SSBs transmitted by the multiple network nodes, or information indicating UE support for the at least one of the CJT mTRP initial access procedure or the progressive refinement initial access procedure.

In a third aspect, alone or in combination with one or more of the first and second aspects, process 600 includes receiving, from multiple network nodes, multiple CSI-RSs, determining, using the multiple CSI-RSs, at least one of phase offsets or frequency offsets associated with the multiple network nodes, and transmitting, using a second message associated with the initial access procedure, an indication of the at least one of the phase offsets or the frequency offsets associated with the multiple network nodes.

In a fourth aspect, alone or in combination with one or more of the first through third aspects, process 600 includes receiving, via the first message, configuration information indicating at least one of an SRS transmission filter associated with the one or more SRS transmissions, an SRS spreading sequence associated with the one or more SRS transmissions, a comb associated with the one or more SRS transmissions, an offset associated with the one or more SRS transmissions, or a power control parameter associated with the one or more SRS transmissions.

In a fifth aspect, alone or in combination with one or more of the first through fourth aspects, the first message further indicates a selected class of SRS configurations to be used for the one or more SRS transmissions, and the process 600 further includes receiving, via a system information block, configuration information indicating multiple candidate SRS configurations, and transmitting, via a second message associated with the initial access procedure, an indication of a selected SRS configuration, of the multiple candidate SRS configurations, that is associated with the selected class of SRS configurations.

In a sixth aspect, alone or in combination with one or more of the first through fifth aspects, the one or more SRS transmissions are associated with the CJT mTRP initial access procedure, and at least one of the one or more SRS transmissions include a first SRS transmission that is transmitted to a first network node and a second SRS transmission that is transmitted to a second network node, or the one or more SRS transmissions include a common SRS transmission that is transmitted to multiple network nodes.

In a seventh aspect, alone or in combination with one or more of the first through sixth aspects, the first message is associated with one of a message 2 associated with a four-step RACH procedure, a message 4 associated with the four-step RACH procedure, or a message B associated with a two-step RACH procedure.

In an eighth aspect, alone or in combination with one or more of the first through seventh aspects, the one or more SRS transmissions are associated with the CJT mTRP initial access procedure, and the indication that triggers the one or more SRS transmissions indicates at least one of multiple path loss reference signals associated with the CJT mTRP initial access procedure, multiple timing advance parameters associated with the one or more SRS transmissions, or multiple offset values associated with the one or more SRS transmissions.

In a ninth aspect, alone or in combination with one or more of the first through eighth aspects, the one or more SRS transmissions are associated with the CJT mTRP initial access procedure, the one or more SRS transmissions include a common SRS transmission that is transmitted to multiple network nodes, and the indication that triggers the one or more SRS transmissions indicates multiple power control coefficients associated with a power control function for transmitting the common SRS transmission to the multiple network nodes.

In a tenth aspect, alone or in combination with one or more of the first through ninth aspects, process 600 includes transmitting, via a second message associated with the initial access procedure, capability information indicating a maximum quantity of power control coefficients supported by the UE.

In an eleventh aspect, alone or in combination with one or more of the first through tenth aspects, the one or more SRS transmissions are associated with the CJT mTRP initial access procedure, and a set of network nodes associated with the CJT mTRP initial access procedure is one of indicated by a network node based at least in part on measurement results transmitted by the UE to the network node, or selected by the UE and reported to the network node via a second message associated with the initial access procedure.

In a twelfth aspect, alone or in combination with one or more of the first through eleventh aspects, transmitting the one or more SRS transmissions includes at least one of transmitting a first SRS transmission, of the one or more SRS transmissions, using a first cyclic shift, and transmitting a second SRS transmission, of the one or more SRS transmissions, using a second cyclic shift that is different from the first cyclic shift; transmitting the first SRS transmission using a first root sequence, and transmitting the second SRS transmission using a second root sequence that is different from the first root sequence; or transmitting the first SRS transmission using a first offset value, and transmitting the second SRS transmission using a second offset value that is different from the first offset value.

In a thirteenth aspect, alone or in combination with one or more of the first through twelfth aspects, the one or more SRS transmissions are associated with the progressive refinement initial access procedure, the first message triggers a first SRS transmission, and the process 600 further includes receiving, via a second message associated with the initial access procedure, an indication that triggers a second SRS transmission.

In a fourteenth aspect, alone or in combination with one or more of the first through thirteenth aspects, transmitting the one or more SRS transmissions includes one of transmitting the first SRS transmission to a first network node, and transmitting the second SRS transmission to a second network node; or transmitting the first SRS transmission to the first network node using a first subset of UE transmission ports, and transmitting the second SRS transmission to the first network node using a second subset of UE transmission ports.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with enabling multiple early SRS transmissions.

As shown in FIG. 7, in some aspects, process 700 may include transmitting, to a UE via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure (block 710). For example, the network node (e.g., using transmission component 904 or communication manager 906, depicted in FIG. 9) may transmit, to a UE via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure, as described above.

As further shown in FIG. 7, in some aspects, process 700 may include receiving, from the UE, at least one SRS transmission, of the one or more SRS transmissions, based at least in part on the transmission of the indication triggering the one or more SRS transmissions (block 720). For example, the network node (e.g., using reception component 902 or communication manager 906, depicted in FIG. 9) may receive, from the UE, at least one SRS transmission, of the one or more SRS transmissions, based at least in part on the transmission of the indication triggering the one or more SRS transmissions, as described above.

Process 700 may include additional aspects, such as any single aspect or any combination of aspects described below or in connection with one or more other processes described elsewhere herein.

In a first aspect, process 700 includes transmitting, to the UE via a system information block, information enabling the at least one of the CJT mTRP initial access procedure or the progressive refinement initial access procedure.

In a second aspect, alone or in combination with the first aspect, process 700 includes receiving, from the UE via a second message associated with the initial access procedure, a report indicating at least one of layer 1 measurement results associated with SSBs transmitted by multiple network nodes, downlink timing differences associated with the SSBs transmitted by the multiple network nodes, or information indicating UE support for the at least one of the CJT mTRP initial access procedure or the progressive refinement initial access procedure.

In a third aspect, alone or in combination with one or more of the first and second aspects, process 700 includes receiving, from the UE using a second message associated with the initial access procedure, an indication of at least one of phase offsets or frequency offsets associated with multiple channel state information reference signals transmitted by multiple network nodes.

In a fourth aspect, alone or in combination with one or more of the first through third aspects, process 700 includes transmitting, to the UE via the first message, configuration information indicating at least one of an SRS transmission filter associated with the one or more SRS transmissions, an SRS spreading sequence associated with the one or more SRS transmissions, a comb associated with the one or more SRS transmissions, an offset associated with the one or more SRS transmissions, or a power control parameter associated with the one or more SRS transmissions.

In a fifth aspect, alone or in combination with one or more of the first through fourth aspects, the first message further indicates a selected class of SRS configurations to be used for the one or more SRS transmissions, and the process 700 further includes transmitting, to the UE via a system information block, configuration information indicating multiple candidate SRS configurations, and receiving, from the UE via a second message associated with the initial access procedure, an indication of a selected SRS configuration, of the multiple candidate SRS configurations, that is associated with the selected class of SRS configurations.

In a sixth aspect, alone or in combination with one or more of the first through fifth aspects, the one or more SRS transmissions are associated with the CJT mTRP initial access procedure, and at least one of: the one or more SRS transmissions include a first SRS transmission that is transmitted to a first network node and a second SRS transmission that is transmitted to a second network node; or the one or more SRS transmissions include a common SRS transmission that is transmitted to multiple network nodes.

In a seventh aspect, alone or in combination with one or more of the first through sixth aspects, the first message is associated with one of a message 2 associated with a four-step RACH procedure, a message 4 associated with the four-step RACH procedure, or a message B associated with a two-step RACH procedure.

In an eighth aspect, alone or in combination with one or more of the first through seventh aspects, the one or more SRS transmissions are associated with the CJT mTRP initial access procedure, and the indication that triggers the one or more SRS transmissions indicates at least one of multiple path loss reference signals associated with the CJT mTRP initial access procedure, multiple timing advance parameters associated with the one or more SRS transmissions, or multiple offset values associated with the one or more SRS transmissions.

In a ninth aspect, alone or in combination with one or more of the first through eighth aspects, the one or more SRS transmissions are associated with the CJT mTRP initial access procedure, the one or more SRS transmissions include a common SRS transmission that is transmitted to multiple network nodes, and the indication that triggers the one or more SRS transmissions indicates multiple power control coefficients associated with a power control function for transmitting the common SRS transmission to the multiple network nodes.

In a tenth aspect, alone or in combination with one or more of the first through ninth aspects, process 700 includes receiving, from the UE via a second message associated with the initial access procedure, capability information indicating a maximum quantity of power control coefficients supported by the UE.

In an eleventh aspect, alone or in combination with one or more of the first through tenth aspects, the one or more SRS transmissions are associated with the CJT mTRP initial access procedure, and a set of network nodes associated with the CJT mTRP initial access procedure are one of indicated by the network node based at least in part on measurement results transmitted by the UE to the network node, or selected by the UE and reported to the network node via a second message associated with the initial access procedure.

In a twelfth aspect, alone or in combination with one or more of the first through eleventh aspects, receiving the at least one SRS transmission, of the one or more SRS transmissions, includes at least one of receiving a first SRS transmission, of the one or more SRS transmissions, using a first cyclic shift, wherein a second SRS transmission, of the one or more SRS transmissions, is transmitted using a second cyclic shift that is different from the first cyclic shift; receiving the first SRS transmission using a first root sequence, wherein the second SRS transmission is transmitted using a second root sequence that is different from the first root sequence; or receiving the first SRS transmission using a first offset value, wherein the second SRS transmission is transmitted using a second offset value that is different from the first offset value.

In a thirteenth aspect, alone or in combination with one or more of the first through twelfth aspects, the one or more SRS transmissions are associated with the progressive refinement initial access procedure, the first message triggers a first SRS transmission, and the process 700 further includes transmitting, to the UE via a second message associated with the initial access procedure, an indication that triggers a second SRS transmission.

In a fourteenth aspect, alone or in combination with one or more of the first through thirteenth aspects, receiving the at least one SRS transmission, of the one or more SRS transmissions, includes one of: receiving the first SRS transmission, wherein the second SRS transmission is transmitted to a second network node; or receiving the first SRS transmission and the second SRS transmission, wherein the first SRS transmission is transmitted using a first subset of UE transmission ports, and wherein the second SRS transmission is transmitted using a second subset of UE transmission ports.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 5A-5C. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure. The transmission component 804 may transmit the one or more SRS transmissions based at least in part on the reception of the indication triggering the one or more SRS transmissions.

The reception component 802 may receive, via a system information block, information enabling the at least one of the CJT mTRP initial access procedure or the progressive refinement initial access procedure.

The transmission component 804 may transmit, via a second message associated with the initial access procedure, a report indicating at least one of layer 1 measurement results associated with SSBs transmitted by multiple network nodes, downlink timing differences associated with the SSBs transmitted by the multiple network nodes, or capability information indicating UE support for the at least one of the CJT mTRP initial access procedure or the progressive refinement initial access procedure.

The reception component 802 may receive, from multiple network nodes, multiple CSI-RSs.

The communication manager 806 may determine, using the multiple CSI-RSs, at least one of phase offsets or frequency offsets associated with the multiple network nodes.

The transmission component 804 may transmit, using a second message associated with the initial access procedure, an indication of the at least one of the phase offsets or the frequency offsets associated with the multiple network nodes.

The reception component 802 may receive, via the first message, configuration information indicating at least one of an SRS transmission filter associated with the one or more SRS transmissions, an SRS spreading sequence associated with the one or more SRS transmissions, a comb associated with the one or more SRS transmissions, an offset associated with the one or more SRS transmissions, or a power control parameter associated with the one or more SRS transmissions.

The transmission component 804 may transmit, via a second message associated with the initial access procedure, capability information indicating a maximum quantity of power control coefficients supported by the UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 5A-5C. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE via a first message associated with an initial access procedure, an indication that triggers one or more SRS transmissions prior to completion of an RRC configuration phase for the UE, wherein the one or more SRS transmissions are associated with at least one of a CJT mTRP initial access procedure or a progressive refinement initial access procedure. The reception component 902 may receive, from the UE, at least one SRS transmission, of the one or more SRS transmissions, based at least in part on the transmission of the indication triggering the one or more SRS transmissions.

The transmission component 904 may transmit, to the UE via a system information block, information enabling the at least one of the CJT mTRP initial access procedure or the progressive refinement initial access procedure.

The reception component 902 may receive, from the UE via a second message associated with the initial access procedure, a report indicating at least one of layer 1 measurement results associated with SSBs transmitted by multiple network nodes, downlink timing differences associated with the SSBs transmitted by the multiple network nodes, or capability information indicating UE support for the at least one of the CJT mTRP initial access procedure or the progressive refinement initial access procedure.

The reception component 902 may receive, from the UE using a second message associated with the initial access procedure, an indication of at least one of phase offsets or frequency offsets associated with multiple channel state information reference signals transmitted by multiple network nodes.

The transmission component 904 may transmit, to the UE via the first message, configuration information indicating at least one of an SRS transmission filter associated with the one or more SRS transmissions, an SRS spreading sequence associated with the one or more SRS transmissions, a comb associated with the one or more SRS transmissions, an offset associated with the one or more SRS transmissions, or a power control parameter associated with the one or more SRS transmissions.

The reception component 902 may receive, from the UE via a second message associated with the initial access procedure, capability information indicating a maximum quantity of power control coefficients supported by the UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving, via a first message associated with an initial access procedure, an indication that triggers one or more sounding reference signal (SRS) transmissions prior to completion of a radio resource control (RRC) configuration phase for the UE, wherein the one or more SRS transmissions are associated with at least one of a coherent joint transmission (CJT) multiple transmission reception point (mTRP) initial access procedure or a progressive refinement initial access procedure; and transmitting the one or more SRS transmissions based at least in part on the reception of the indication triggering the one or more SRS transmissions.
Aspect 2: The method of Aspect 1, further comprising receiving, via a system information block, information enabling the at least one of the CJT mTRP initial access procedure or the progressive refinement initial access procedure.
Aspect 3: The method of any of Aspects 1-2, further comprising transmitting, via a second message associated with the initial access procedure, a report indicating at least one of: layer 1 measurement results associated with synchronization signal blocks (SSBs) transmitted by multiple network nodes, downlink timing differences associated with the SSBs transmitted by the multiple network nodes, or capability information indicating UE support for the at least one of the CJT mTRP initial access procedure or the progressive refinement initial access procedure.
Aspect 4: The method of any of Aspects 1-3, further comprising: receiving, from multiple network nodes, multiple channel state information reference signals (CSI-RSs); determining, using the multiple CSI-RSs, at least one of phase offsets or frequency offsets associated with the multiple network nodes; and transmitting, using a second message associated with the initial access procedure, an indication of the at least one of the phase offsets or the frequency offsets associated with the multiple network nodes.
Aspect 5: The method of any of Aspects 1-4, further comprising receiving, via the first message, configuration information indicating at least one of: an SRS transmission filter associated with the one or more SRS transmissions, an SRS spreading sequence associated with the one or more SRS transmissions, a comb associated with the one or more SRS transmissions, an offset associated with the one or more SRS transmissions, or a power control parameter associated with the one or more SRS transmissions.
Aspect 6: The method of any of Aspects 1-5, wherein the first message further indicates a selected class of SRS configurations to be used for the one or more SRS transmissions, and wherein the method further comprises: receiving, via a system information block, configuration information indicating multiple candidate SRS configurations; and transmitting, via a second message associated with the initial access procedure, an indication of a selected SRS configuration, of the multiple candidate SRS configurations, that is associated with the selected class of SRS configurations.
Aspect 7: The method of any of Aspects 1-6, wherein the one or more SRS transmissions are associated with the CJT mTRP initial access procedure, and wherein at least one of: the one or more SRS transmissions include a first SRS transmission that is transmitted to a first network node and a second SRS transmission that is transmitted to a second network node, or the one or more SRS transmissions include a common SRS transmission that is transmitted to multiple network nodes.
Aspect 8: The method of any of Aspects 1-7, wherein the first message is associated with one of: a message 2 associated with a four-step random access channel (RACH) procedure, a message 4 associated with the four-step RACH procedure, or a message B associated with a two-step RACH procedure.
Aspect 9: The method of any of Aspects 1-8, wherein the one or more SRS transmissions are associated with the CJT mTRP initial access procedure, and wherein the indication that triggers the one or more SRS transmissions indicates at least one of: multiple path loss reference signals associated with the CJT mTRP initial access procedure, multiple timing advance parameters associated with the one or more SRS transmissions, or multiple offset values associated with the one or more SRS transmissions.
Aspect 10: The method of any of Aspects 1-9, wherein the one or more SRS transmissions are associated with the CJT mTRP initial access procedure, wherein the one or more SRS transmissions include a common SRS transmission that is transmitted to multiple network nodes, and wherein the indication that triggers the one or more SRS transmissions indicates multiple power control coefficients associated with a power control function for transmitting the common SRS transmission to the multiple network nodes.
Aspect 11: The method of Aspect 10, further comprising transmitting, via a second message associated with the initial access procedure, capability information indicating a maximum quantity of power control coefficients supported by the UE.
Aspect 12: The method of any of Aspects 1-11, wherein the one or more SRS transmissions are associated with the CJT mTRP initial access procedure, and wherein a set of network nodes associated with the CJT mTRP initial access procedure is one of: indicated by a network node based at least in part on measurement results transmitted by the UE to the network node, or selected by the UE and reported to the network node via a second message associated with the initial access procedure.
Aspect 13: The method of any of Aspects 1-12, wherein transmitting the one or more SRS transmissions includes at least one of: transmitting a first SRS transmission, of the one or more SRS transmissions, using a first cyclic shift, and transmitting a second SRS transmission, of the one or more SRS transmissions, using a second cyclic shift that is different from the first cyclic shift, transmitting the first SRS transmission using a first root sequence, and transmitting the second SRS transmission using a second root sequence that is different from the first root sequence, or transmitting the first SRS transmission using a first offset value, and transmitting the second SRS transmission using a second offset value that is different from the first offset value.
Aspect 14: The method of any of Aspects 1-13, wherein the one or more SRS transmissions are associated with the progressive refinement initial access procedure, wherein the first message triggers a first SRS transmission, and wherein the method further comprises receiving, via a second message associated with the initial access procedure, an indication that triggers a second SRS transmission.
Aspect 15: The method of Aspect 14, wherein transmitting the one or more SRS transmissions includes one of: transmitting the first SRS transmission to a first network node, and transmitting the second SRS transmission to a second network node, or transmitting the first SRS transmission to the first network node using a first subset of UE transmission ports, and transmitting the second SRS transmission to the first network node using a second subset of UE transmission ports.
Aspect 16: A method of wireless communication performed by a network node, comprising: transmitting, to a user equipment (UE) via a first message associated with an initial access procedure, an indication that triggers one or more sounding reference signal (SRS) transmissions prior to completion of a radio resource control (RRC) configuration phase for the UE, wherein the one or more SRS transmissions are associated with at least one of a coherent joint transmission (CJT) multiple transmission reception point (mTRP) initial access procedure or a progressive refinement initial access procedure; and receiving, from the UE, at least one SRS transmission, of the one or more SRS transmissions, based at least in part on the transmission of the indication triggering the one or more SRS transmissions.
Aspect 17: The method of Aspect 16, further comprising transmitting, to the UE via a system information block, information enabling the at least one of the CJT mTRP initial access procedure or the progressive refinement initial access procedure.
Aspect 18: The method of any of Aspects 16-17, further comprising receiving, from the UE via a second message associated with the initial access procedure, a report indicating at least one of: layer 1 measurement results associated with synchronization signal blocks (SSBs) transmitted by multiple network nodes, downlink timing differences associated with the SSBs transmitted by the multiple network nodes, or capability information indicating UE support for the at least one of the CJT mTRP initial access procedure or the progressive refinement initial access procedure.
Aspect 19: The method of any of Aspects 16-18, further comprising receiving, from the UE using a second message associated with the initial access procedure, an indication of at least one of phase offsets or frequency offsets associated with multiple channel state information reference signals transmitted by multiple network nodes.
Aspect 20: The method of any of Aspects 16-19, further comprising transmitting, to the UE via the first message, configuration information indicating at least one of: an SRS transmission filter associated with the one or more SRS transmissions, an SRS spreading sequence associated with the one or more SRS transmissions, a comb associated with the one or more SRS transmissions, an offset associated with the one or more SRS transmissions, or a power control parameter associated with the one or more SRS transmissions.
Aspect 21: The method of any of Aspects 16-20, wherein the first message further indicates a selected class of SRS configurations to be used for the one or more SRS transmissions, and wherein the method further comprises: transmitting, to the UE via a system information block, configuration information indicating multiple candidate SRS configurations; and receiving, from the UE via a second message associated with the initial access procedure, an indication of a selected SRS configuration, of the multiple candidate SRS configurations, that is associated with the selected class of SRS configurations.
Aspect 22: The method of any of Aspects 16-21, wherein the one or more SRS transmissions are associated with the CJT mTRP initial access procedure, and wherein at least one of: the one or more SRS transmissions include a first SRS transmission that is transmitted to a first network node and a second SRS transmission that is transmitted to a second network node, or the one or more SRS transmissions include a common SRS transmission that is transmitted to multiple network nodes.
Aspect 23: The method of any of Aspects 16-22, wherein the first message is associated with one of: a message 2 associated with a four-step random access channel (RACH) procedure, a message 4 associated with the four-step RACH procedure, or a message B associated with a two-step RACH procedure.
Aspect 24: The method of any of Aspects 16-23, wherein the one or more SRS transmissions are associated with the CJT mTRP initial access procedure, and wherein the indication that triggers the one or more SRS transmissions indicates at least one of: multiple path loss reference signals associated with the CJT mTRP initial access procedure, multiple timing advance parameters associated with the one or more SRS transmissions, or multiple offset values associated with the one or more SRS transmissions.
Aspect 25: The method of any of Aspects 16-24, wherein the one or more SRS transmissions are associated with the CJT mTRP initial access procedure, wherein the one or more SRS transmissions include a common SRS transmission that is transmitted to multiple network nodes, and wherein the indication that triggers the one or more SRS transmissions indicates multiple power control coefficients associated with a power control function for transmitting the common SRS transmission to the multiple network nodes.
Aspect 26: The method of Aspect 25, further comprising receiving, from the UE via a second message associated with the initial access procedure, capability information indicating a maximum quantity of power control coefficients supported by the UE.
Aspect 27: The method of any of Aspects 16-26, wherein the one or more SRS transmissions are associated with the CJT mTRP initial access procedure, and wherein a set of network nodes associated with the CJT mTRP initial access procedure are one of: indicated by the network node based at least in part on measurement results transmitted by the UE to the network node, or selected by the UE and reported to the network node via a second message associated with the initial access procedure.
Aspect 28: The method of any of Aspects 16-27, wherein receiving the at least one SRS transmission, of the one or more SRS transmissions, includes at least one of: receiving a first SRS transmission, of the one or more SRS transmissions, using a first cyclic shift, wherein a second SRS transmission, of the one or more SRS transmissions, is transmitted using a second cyclic shift that is different from the first cyclic shift, receiving the first SRS transmission using a first root sequence, wherein the second SRS transmission is transmitted using a second root sequence that is different from the first root sequence, or receiving the first SRS transmission using a first offset value, wherein the second SRS transmission is transmitted using a second offset value that is different from the first offset value.
Aspect 29: The method of any of Aspects 16-28, wherein the one or more SRS transmissions are associated with the progressive refinement initial access procedure, wherein the first message triggers a first SRS transmission, and wherein the method further comprises transmitting, to the UE via a second message associated with the initial access procedure, an indication that triggers a second SRS transmission.
Aspect 30: The method of Aspect 29, wherein receiving the at least one SRS transmission, of the one or more SRS transmissions, includes one of: receiving the first SRS transmission, wherein the second SRS transmission is transmitted to a second network node, or receiving the first SRS transmission and the second SRS transmission, wherein the first SRS transmission is transmitted using a first subset of UE transmission ports, and wherein the second SRS transmission is transmitted using a second subset of UE transmission ports.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.
Aspect 38: A device comprising a processing system that includes one or more processors and one or more code-storing memories coupled with the one or more processors, the processing system configured to cause the device to perform the method of one or more of Aspects 1-30.
Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, via a first message associated with an initial access procedure, an indication that triggers one or more sounding reference signal (SRS) transmissions prior to completion of a radio resource control (RRC) configuration phase for the UE,
wherein the one or more SRS transmissions are associated with at least one of a coherent joint transmission (CJT) multiple transmission reception point (mTRP) initial access procedure or a progressive refinement initial access procedure; and
transmit the one or more SRS transmissions based at least in part on the reception of the indication triggering the one or more SRS transmissions.

2. The UE of claim 1, wherein the processing system is configured to cause the UE to receive, via a system information block, information enabling the at least one of the CJT mTRP initial access procedure or the progressive refinement initial access procedure.

3. The UE of claim 1, wherein the processing system is configured to cause the UE to transmit, via a second message associated with the initial access procedure, a report indicating at least one of:
layer 1 measurement results associated with synchronization signal blocks (SSBs) transmitted by multiple network nodes,
downlink timing differences associated with the SSBs transmitted by the multiple network nodes, or
information indicating UE support for the at least one of the CJT mTRP initial access procedure or the progressive refinement initial access procedure.

4. The UE of claim 1, wherein the processing system is configured to cause the UE to:
receive, from multiple network nodes, multiple channel state information reference signals (CSI-RSs);
determine, using the multiple CSI-RSs, at least one of phase offsets or frequency offsets associated with the multiple network nodes; and
transmit, using a second message associated with the initial access procedure, an indication of the at least one of the phase offsets or the frequency offsets associated with the multiple network nodes.

5. The UE of claim 1, wherein the processing system is configured to cause the UE to receive, via the first message, configuration information indicating at least one of:
an SRS transmission filter associated with the one or more SRS transmissions,
an SRS spreading sequence associated with the one or more SRS transmissions,
a comb associated with the one or more SRS transmissions,
an offset associated with the one or more SRS transmissions, or
a power control parameter associated with the one or more SRS transmissions.

6. The UE of claim 1, wherein the first message further indicates a selected class of SRS configurations to be used for the one or more SRS transmissions, and wherein the processing system is further configured to cause the UE to:
receive, via a system information block, configuration information indicating multiple candidate SRS configurations; and
transmit, via a second message associated with the initial access procedure, an
indication of a selected SRS configuration, of the multiple candidate SRS configurations, that is associated with the selected class of SRS configurations.

7. The UE of claim 1, wherein the one or more SRS transmissions are associated with the CJT mTRP initial access procedure, and wherein at least one of:
the one or more SRS transmissions include a first SRS transmission that is transmitted to a first network node and a second SRS transmission that is transmitted to a second network node, or
the one or more SRS transmissions include a common SRS transmission that is transmitted to multiple network nodes.

8. The UE of claim 1, wherein the first message is associated with one of:
a message 2 associated with a four-step random access channel (RACH) procedure,
a message 4 associated with the four-step RACH procedure, or
a message B associated with a two-step RACH procedure.

9. The UE of claim 1, wherein the one or more SRS transmissions are associated with the CJT mTRP initial access procedure, and wherein the indication that triggers the one or more SRS transmissions indicates at least one of:
multiple path loss reference signals associated with the CJT mTRP initial access procedure,
multiple timing advance parameters associated with the one or more SRS transmissions, or
multiple offset values associated with the one or more SRS transmissions.

10. The UE of claim 1, wherein the one or more SRS transmissions are associated with the CJT mTRP initial access procedure,
wherein the one or more SRS transmissions include a common SRS transmission that is transmitted to multiple network nodes, and
wherein the indication that triggers the one or more SRS transmissions indicates multiple power control coefficients associated with a power control function for transmitting the common SRS transmission to the multiple network nodes.

11. The UE of claim 10, wherein the processing system is configured to cause the UE to transmit, via a second message associated with the initial access procedure, capability information indicating a maximum quantity of power control coefficients supported by the UE.

12. The UE of claim 1, wherein the one or more SRS transmissions are associated with the CJT mTRP initial access procedure, and wherein a set of network nodes associated with the CJT mTRP initial access procedure is one of:
indicated by a network node based at least in part on measurement results transmitted by the UE to the network node, or
selected by the UE and reported to the network node via a second message associated with the initial access procedure.

13. The UE of claim 1, wherein the processing system, to cause the UE to transmit the one or more SRS transmissions, is configured to cause the UE to:
transmit a first SRS transmission, of the one or more SRS transmissions, using a first cyclic shift, and transmitting a second SRS transmission, of the one or more SRS transmissions, using a second cyclic shift that is different from the first cyclic shift, transmit the first SRS transmission using a first root sequence, and transmitting the second SRS transmission using a second root sequence that is different from the first root sequence, or
transmit the first SRS transmission using a first offset value, and transmitting the second SRS transmission using a second offset value that is different from the first offset value.

14. The UE of claim 1, wherein the one or more SRS transmissions are associated with the progressive refinement initial access procedure,
wherein the first message triggers a first SRS transmission, and
wherein the processing system is further configured to cause the UE to receive, via a
second message associated with the initial access procedure, an indication that triggers a second SRS transmission.

15. The UE of claim 14, wherein the processing system, to cause the UE to transmit the one or more SRS transmissions, is configured to cause the UE to:
transmit the first SRS transmission to a first network node, and transmit the second SRS transmission to a second network node, or
transmit the first SRS transmission to the first network node using a first subset of UE transmission ports, and transmit the second SRS transmission to the first network node using a second subset of UE transmission ports.

16. A network node, comprising:
a processing system that includes one or more processors and one or more code-storing memories coupled with the one or more processors, the processing system configured to cause the network node to:
transmit, to a user equipment (UE) via a first message associated with an initial access procedure, an indication that triggers one or more sounding reference signal (SRS) transmissions prior to completion of a radio resource control (RRC) configuration phase for the UE,
wherein the one or more SRS transmissions are associated with at least one of a coherent joint transmission (CJT) multiple transmission reception point (mTRP) initial access procedure or a progressive refinement initial access procedure; and
receive, from the UE, at least one SRS transmission, of the one or more SRS transmissions, based at least in part on the transmission of the indication triggering the one or more SRS transmissions.

17. The network node of claim 16, wherein the one or more SRS transmissions are associated with the CJT mTRP initial access procedure, and wherein at least one of:
the one or more SRS transmissions include a first SRS transmission that is transmitted to a first network node and a second SRS transmission that is transmitted to a second network node, or
the one or more SRS transmissions include a common SRS transmission that is transmitted to multiple network nodes.

18. The network node of claim 16, wherein the one or more SRS transmissions are associated with the CJT mTRP initial access procedure, and
wherein a set of network nodes associated with the CJT mTRP initial access procedure are one of:
indicated by the network node based at least in part on measurement results transmitted by the UE to the network node, or
selected by the UE and reported to the network node via a second message associated with the initial access procedure.

19. The network node of claim 16, wherein the one or more SRS transmissions are associated with the progressive refinement initial access procedure, wherein the first message triggers a first SRS transmission, and wherein the processing system is further configured to cause the network node to transmit, to the UE via a second message associated with the initial access procedure, an indication that triggers a second SRS transmission.

20. A method of wireless communication performed by a user equipment (UE), comprising:
receiving, via a first message associated with an initial access procedure, an indication that triggers one or more sounding reference signal (SRS) transmissions prior to completion of a radio resource control (RRC) configuration phase for the UE,
wherein the one or more SRS transmissions are associated with at least one of a coherent joint transmission (CJT) multiple transmission reception point (mTRP) initial access procedure or a progressive refinement initial access procedure; and
transmitting the one or more SRS transmissions based at least in part on the reception of the indication triggering the one or more SRS transmissions.
